(19) United States
(12) Patent Application Publication
(10) Pub. No.: US 2004/0151074 A1
(43) Pub. Date: Aug. 5, 2004

(54) Time measurement using distance of charge movement

(76) Inventor: Kurt E. Spears, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 10/355,691

(22) Filed: Jan. 31, 2003

(51) Int. Cl. G04F 10/00; G04F 8/00

(52) U.S. Cl. 368/113

(57) ABSTRACT

An electronic measurement device uses a charge distance movement as a measure of elapsed time. After a start time, a charge transfer register receives charge. An electronic field across the charge transfer register causes motion of the charge within the charge transfer register. Measurement of the distance moved by the charge during a predetermined time provides a measurement of elapsed time between the start time and time of receiving charge.

### FIELD OF INVENTION

This invention relates generally to electronic measurement of time.

### BACKGROUND

There is a general need for measurement of elapsed time, particularly for short periods of time. For example, electronic distance measurement sometimes involves measurement of time of flight for light or sound. Some surveying instruments transmit light pulses, and measure the time of flight between transmission of a light pulse and detection of the light pulse at a sensor (after reflection from a remote reflector). Similarly, sonar, some camera focus distance measurement devices, and some instruments used for making approximate measurements of rooms in a house, transmit sound pulses, and measure the time of flight between transmission of a sound pulse and detection of the sound pulse at a sensor (after reflection from a remote surface).

### SUMMARY

An electronic measurement device uses a charge distance movement as a measure of elapsed time. After a start time, a charge transfer register receives charge. An electronic field across the charge transfer register causes motion of the charge within the charge transfer register. Measurement of the distance moved by the charge during a predetermined time provides a measurement of elapsed time between the start time and time of receiving charge.

### BRIEF DESCRIPTION OF THE DRAWINGS

FIG. 1 is a block diagram of an example embodiment of an apparatus.

FIGS. 2A, 2B, 2C, and 2D are timing diagrams for signals associated with the apparatus of FIG. 1.

FIG. 3 is a flow chart of an example embodiment of a method.

FIGS. 4A, 4B, and 4C are block diagrams of example embodiments of two-dimensional CCD arrays suitable for use as imaging arrays and for distance measurement.

FIG. 5 is a block diagram of an example embodiment of a camera in which the invention may be implemented.

### DETAILED DESCRIPTION

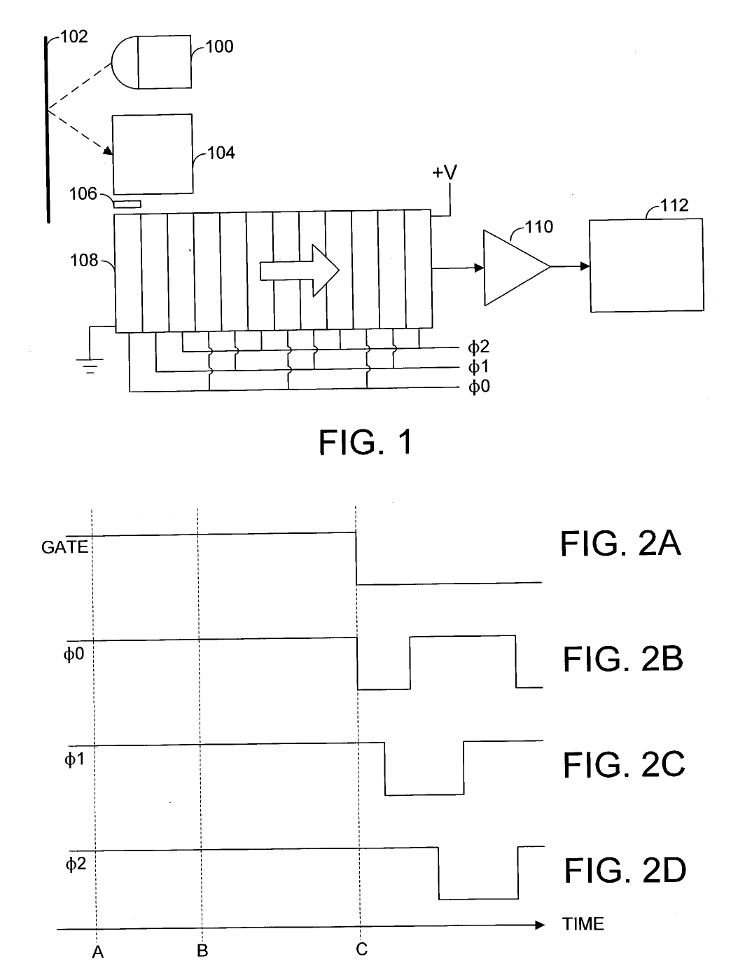

FIG. 1 illustrates an example embodiment of a system for measuring time-of-flight of light using a charge transfer register (also known as a serial readout register). In FIG. 1, a light source 100 provides light that reflects from a surface 102 onto a photosensor 104. Photosensor 104 generates electric charge in response to light energy. A charge transfer gate 106 may be switched on, permitting charge to flow from the photosensor through the charge transfer gate to one stage of a charge transfer register 108. A voltage bias along the length of the charge transfer register provides a force to move charge toward an amplifier 110. The amplifier 110 receives electric charge from the charge transfer register and converts the received charge to a voltage. An analog-to-digital (A/D) converter 112 converts the voltage to a numerical value suitable for use by a processor (not illustrated).

Charge transfer registers are typically split into multiple phases so that during shifting, each charge is shifted into an empty stage in a controlled direction. Two, three, and four phase charge transfer registers are known. The example of FIG. 1 depicts a three-phase charge transfer register, in which three phase-control signals (φ0, φ1, and φ2) are used to control sequential transfer of charges between adjacent stages.

In an initial phase for time-of-flight measurement, a gate control signal GATE causes the charge transfer gate 106 to open, and the phase control signals (φ0, φ1, and φ2) are set to a state enabling charge to flow unimpeded from one end of the charge transfer register toward the opposite end, at a velocity determined by a voltage bias along the length of the charge transfer register (electric field strength) and the mobility of electrons in the semiconductor material of the charge transfer register. After a short period of time, the charge transfer gate 106 is closed, and the phase control signals are set to states such that some charge is trapped in individual stages of the charge transfer register. Those charges are then sequentially transferred to the amplifier and A/D converter. The resulting numerical values are analyzed to determine time-of-flight of light from the light source 100 to the photosensor 104.

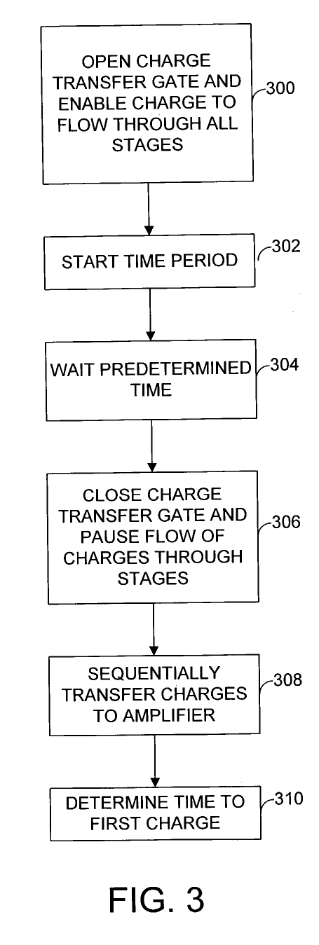

FIGS. 2A-2D illustrate timing of various events and signals, assuming (for example only) a three-phase charge transfer register. FIG. 2A illustrates the gate control signal GATE controlling the charge transfer gate (FIG. 1, 106). FIG. 2B illustrates phase control signal φ0, FIG. 2C illustrates phase control signal φ1, and FIG. 2D illustrates phase control signal φ2. At time A, a time period is started that ends at time C. The lamp (FIG. 1, 100) is turned on to provide light at some known time relative to time A. For example, if there is a known delay before the lamp actually fires, the lamp may be turned on before time A. At unknown time B, reflected light reaches the photosensor (FIG. 1, 104). Sometime before time B, the charge transfer gate is turned on (FIG. 2A) and the three phase control signals (FIGS. 2B, 2C, and 2D) are placed in a state such that there are no barriers to charge flow along the entire length of the charge transfer register (FIG. 1, 108). As a result, at time B, charge from photosensor 104 enters the charge transfer register and is swept toward the amplifier (FIG. 1, 110) by an electric field. At time C, at the end of the time period, the charge transfer gate is closed, and some of the barriers between stages in the charge transfer register are closed, so that a distribution of charges is trapped in the stages of the charge transfer register. After time C, the three phase control signals are sequentially controlled to cause discrete packets of charge to be sequentially transferred to the amplifier and A/D converter for conversion to digital values. As a result, the system uses the movement of charge to determine when time B occurred relative to time A.

The following numerical example is for purposes of illustration only. Assume that the charge transfer register has 1000 stages with a pitch of 2 micrometers. The total length of the charge transfer register is then 2000 micrometers (0.2 cm). Assume that +V in FIG. 1 is 12 volts, so that the resulting electric field is 60 v/cm. Assume that the charge transfer register is fabricated in silicon, and the resulting electron mobility is 600 cm²/volt-sec. The velocity of an electron in the charge transfer register is the electron mobility times the electric field strength, which for the example numbers is 36,000 cm/sec. The transit time for an electron over the entire length of the charge transfer register is then 5.6*10⁻⁷ seconds. Accordingly, time C may be set to about 5.6*10⁻⁷ seconds after time A. If it is known that no object will be closer than some minimum distance, then time A may be started at an offset after the light is initiated. With 1,000 stages, the time per stage is 5.6*10⁻¹⁰ seconds per stage.

The velocity of light in the atmosphere is approximately 3*10⁸ meters per second. The transit time for an electron over the length of the charge transfer register corresponds to about 168 meters of travel for light. For the example of a reflecting surface, the transit time for an electron over the length of the charge transfer register corresponds to a surface that is 84 meters away for a round trip of 168 meters for the light. With 1,000 stages, each stage corresponds to about 16.8 cm of light travel through the atmosphere, or 8.4 cm of distance from the light source to the surface. FIG. 1 assumes light reflected from a surface for a round trip time, but the system could have a remote light source and measure the time of flight from the remote light source directly to the photosensor.

When the charges are then transferred to the amplifier and A/D converter, any charge in the stage closest to the amplifier indicates that light was reflected very close to the photosensor (or close to the minimum distance if time A is offset for a minimum distance). If charges first appear at a stage that is N stages from the amplifier, then the reflecting surface was N*8.4 cm from the light source. If there are no charges in the charge transfer register, then the light source was more than 168 meters away, or the reflecting surface was more than 84 meters away from the light source. Accuracy can be improved by increasing the field strength, or by increasing the number of register stages (reducing the register pitch, or making the register longer with a proportionate increase in voltage to maintain the same field strength). In addition, averaging of multiple measurements and interpolation of values between register stages can provide additional accuracy. In particular, there will be some finite rise time for light generation, and some finite rise time for charge from the photosensor. A curve may be fitted through values from multiple charge transfer register stages to determine a more accurate time/distance for the start of charge generation. In addition, instead of a simple reflecting surface as depicted by surface 102 in FIG. 1, there may be many complex surfaces reflecting light. Accordingly, values from many charge transfer register stages may be evaluated to determine a dominate object distance. For example, a small close object may provide an initial reflection, and a larger more distant object may provide a later greater reflection, and a system may choose to ignore the reflection from the small object.

In the above discussion, charge flows unimpeded from one end of the charge transfer register toward the opposite end. Typically, if every phase-control signal for a three-phase or four-phase charge transfer register is at the same voltage, then the well potential (transverse to the end-to-end electric field) for each stage of the charge transfer register is the same. In contrast, in some two-phase charge transfer registers, the well potential for alternate stages is intentionally offset by varying an oxide thickness under the gate contacts. This variable oxide thickness facilitates transfer of charge in a controlled direction. However, if each phase-control signal in such a system is set to the same voltage, some charge will be trapped in alternate stages. One solution to this problem is to inject charge before time A in FIGS. 2A-2D, so that at time A the stages that trap charge will have a known initial charge. These known initial charges may then be subtracted from charges from the affected stages during processing.

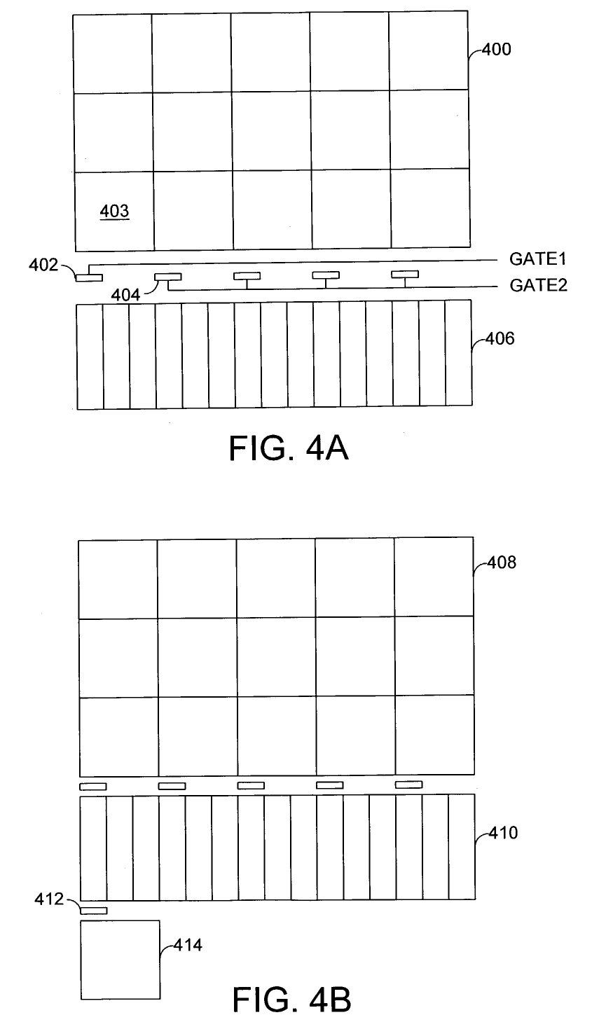

FIG. 3 illustrates an example method. At step 300, a charge transfer gate is opened, and phase control signals are set to a state that enables charge to flow unimpeded through all stages of the charge transfer register. At step 302, a time period is started (FIGS. 2A-2D, time A). In the case of distance measurement using light, step 302 may also correspond to turning on a light source. Note that there is no required fixed time relationship or required sequential order between steps 300 and 302. Step 300 may occur after step 302. Step 300 needs to occur before light reaches the photosensor. Preferably, step 300 is performed early enough to enable any accumulated charge in the charge transfer register to be eliminated before light reaches the photosensor. Preferably, step 300 is performed early enough to enable a measurement of background light for determination of a threshold. At step 304, the system waits a predetermined time duration (for example, FIGS. 2A-2D, time C minus time A). At the end of the predetermined time duration, at step 306, the charge transfer gate is closed, and flow of charges through the stages is paused. At step 308, the phase control signals are cycled to sequentially transfer charge in each stage to the amplifier, and on to the A/D converter. At step 310, time of generation of a charge relative to the start of the time period is determined by analysis of the resulting numerical values.

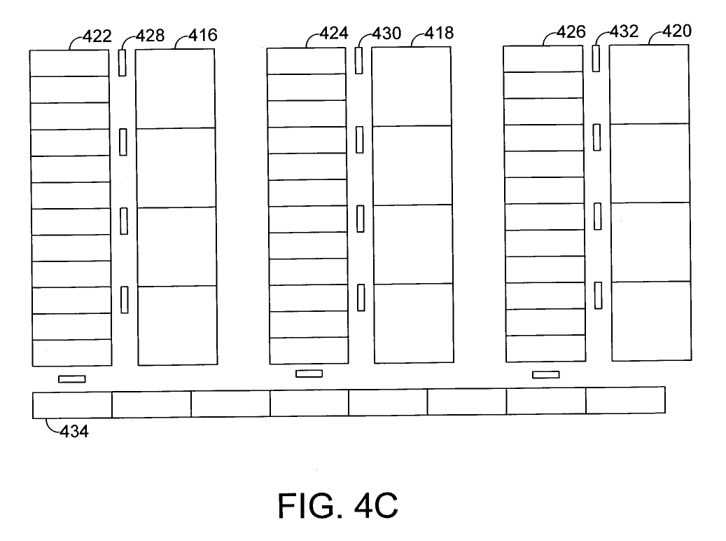

A Charge Coupled Device (CCD) array used for optical image scanners commonly has a linear array of photosensors coupled to a charge transfer register. A CCD array used for digital cameras commonly has a two-dimensional array of photosensors and at least one charge transfer register. Charges are transferred by rows from one photosensor to the next and finally to the charge transfer register. Alternatively, charges may be transferred to interline charge transfer registers, and from interline charge transfer registers to a final charge transfer register. Charge transfer registers used for many types of CCD arrays can be used for the system of FIG. 1 with some modification. FIGS. 4A and 4B illustrate examples of two-dimensional CCD arrays with a charge transfer register that can be used for both imaging and distance measurement.

In FIG. 4A, a two-dimensional array of photosensors 400 transfers charges to a horizontal charge transfer register 406. One charge transfer gate 402 is provided with a separate control signal line (GATE1). The remaining charge transfer gates 404 have a common control signal line (GATE2). One imaging photosensor 403 is used for both imaging and for distance measurement. When the array is used for distance measurement, only gate 402 is opened. When the array is used for imaging, all gates are opened. When only gate 402 is opened, only charge from photosensor 403 flows into the charge transfer register.

In FIG. 4B, a two-dimensional array of photosensors 408 transfers charges to a horizontal charge transfer register 410. A separate charge transfer gate 412 can transfer charge from a separate photosensor 414 to the charge transfer register. The charge transfer register 410 can be used for distance measurement or for imaging.

In FIG. 4C, in a two-dimensional array of photosensors, each column of photosensors (416, 418, 420) has a separate interline charge transfer register (422, 424, and 426). In the example illustrated, one gate for each column (428, 430, 432) may have a separate control line, as illustrated in FIG. 4A. Charges from the interline charge transfer registers are sequentially transferred to a horizontal charge transfer register 434, and are then transferred to an amplifier and A/D converter (not illustrated). In the example embodiment of FIG. 4C, many simultaneous measurements may be made. If the object reflecting light is three-dimensional, then multiple distances may be measured. By moving the photosensor array relative to the object, and flashing a light source for each raster line, a three-dimensional measurement of shape may be provided.

A distance measuring device as described above is particularly suitable for use in a camera (either a film camera or a digital camera) as part of an auto-focus control system and as part of a strobe control system. Cameras with fully automatic focusing commonly analyze a digital image from a photosensor array and adjust the focal distance of a lens until image edge contrast is maximized. Typically, the focusing algorithm provides a measure of focus, but does not indicate a direction to move a lens to improve the focus. As a result, auto-focus may be a trial and error process, and sometimes auto-focus may fail, or may take a substantial amount of time. A distance measuring device as described above is particularly suitable for establishing an initial focal distance for a lens. In addition, a distance measurement may indicate a subject distance to determine strobe energy for a strobe system.

For a digital camera, a two-dimensional CCD array can be used for both imaging and distance measurement (as illustrated in the examples of FIGS. 4A and 4C). The only modification required to a conventional CCD array is the ability to gate charge into only one stage of the charge transfer register, and the ability to control the phase signals so that charges can flow through the stages unimpeded (or initialize charge as discussed above for some two-phase charge transfer registers). Alternatively, a conventional CCD array could be modified by adding an additional photosensor and charge transfer gate, as illustrated in the example of FIG. 4B.

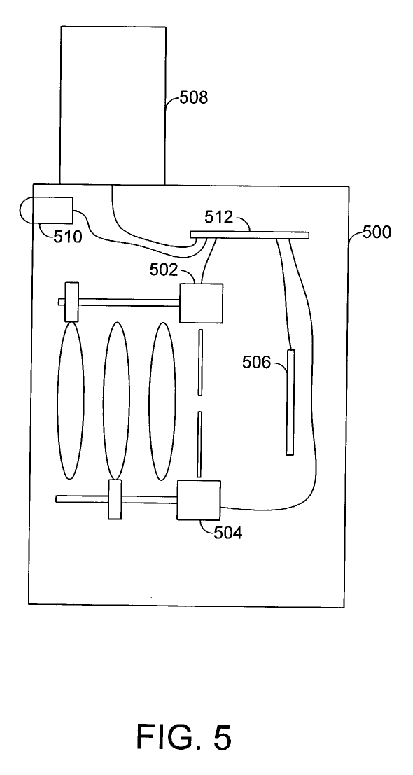

FIG. 5 illustrates an example camera. In FIG. 5, a camera 500 includes an example lens system with automatic focus. In the example of FIG. 5, a first motor 502, and a second motor 504, each drives a lead screw, which is attached to a follower nut attached to a moveable group of lens elements. The moveable groups of elements are moved independently to provide both zoom and focus. A photosensor array 506 is used for focus control and exposure control. In a digital camera, the photosensor array 506 may also be used as the imaging array. A strobe 508 is used in low-light conditions. The strobe may or may not be attached to the camera. The strobe 508 may be used as a light source for distance measurement. Alternatively, an optional separate light source 510, such as a small LED, may be used for distance measurement. A processor/controller 512 receives images, light intensity data, or distance data from the photosensor array 506, and controls the lens system, the strobe, the distance measurement light source (if separate), and may be used to compute distance.

Distance measurement as discussed above may be implemented in camera 500. The light source 510 (or strobe 508) may be flashed, and photosensor array 506 may be used in conjunction with processor 512 to determine distance to a dominant object. The focal distance of the lens may then be adjusted to the distance to that object. For a digital camera, an auto-focus algorithm based on maximizing image edge contrast may be used in addition to distance measurement. That is, distance measurement may be used for initial focus, and focus may be refined using image edge contrast if appropriate.

Optical distance measurement is just one example of a use for a device that can measure elapsed time. In addition, a CCD or other photosensor is just one example of a way to generate a charge to transfer into a charge-transfer register. In general, as illustrated in FIG. 3, a charge-transfer register can be used to measure when a charge or current was generated relative to the start of a time period. There are many physical phenomena that can be detected electronically, so that when a first event occurs, a time period is started, and when a second event occurs at an unknown time to be measured, charge or current is generated.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An apparatus where distance traveled by charge in a semiconductor device provides a measure of time interval.

2. The apparatus of claim 1 where the semiconductor device comprises a charge transfer register.

3. The apparatus of claim 2, further comprising:
a photosensor;
the charge transfer register having a first stage, a second stage, and a plurality of stages between the first stage and the second stage;
where charge from the photosensor passes into the first stage and is permitted to move from the first stage toward the second stage through the plurality of stages between the first stage and the second stage for a predetermined time without pausing in any one stage.

4. The apparatus of claim 3, where the photosensor is one photosensor within an array of photosensors.

5. The apparatus of claim 4, where the array of photosensors is a two-dimensional array of photosensors.

6. A method comprising:
establishing a reference time;
transferring charge to a charge transfer register;
permitting the charge to move through the charge transfer register for a predetermined time;
determining a time of transfer of charge relative to the reference time based on a distance the charge moved within the charge transfer register.

7. A method comprising:
initiating light;
receiving the light by a photosensor;
transferring charge from the photosensor to a charge transfer register;
permitting the charge to move through the charge transfer register for a predetermined time;
determining a distance traveled by the light based on a distance the charge moved within the charge transfer register.

8. A camera comprising:
a photosensor array including a charge transfer register, where the charge transfer register is used for measuring time of flight of light from the camera to an object and back to the camera.

9. An apparatus, comprising:
means for receiving electric charge;
means for moving the charge along a semiconductor device;
means for determining a distance moved by the charge; and
means for determining a time interval based on the distance moved by the charge.

10. An apparatus, comprising:
means for sending light;
means for receiving the light;
means for converting the light to charge;
means for moving the charge along a semiconductor device;
means for determining a distance moved by the charge; and
means for determining a distance traveled by the light based on the distance moved by the charge.
